(19) United States
(12) Patent Application Publication
(10) Pub. No.: US 2026/0277531 A1
(43) Pub. Date: Sep. 17, 2026

(54) AUDIO PROCESSING

(71) Applicant: Cirrus Logic International Semiconductor Ltd., Edinburgh (GB)

(72) Inventors: Stephen MCKINLEY, Brookwood (GB); Gavin COCHRANE, London (GB); Iain MACPHERSON, London (GB)

(73) Assignee: Cirrus Logic International Semiconductor Ltd., Edinburgh (GB)

(21) Appl. No.: 19/095,950

(22) Filed: Mar. 31, 2025

Related U.S. Application Data
(60) Provisional application No. 63/770,048, filed on Mar. 11, 2025.

(51) Int. Cl. G06F 3/16; G10K 11/178

(52) U.S. Cl. CPC G06F 3/162; G06F 3/165; G10K 11/17825; G10K 11/1785

(57) ABSTRACT

A computer-implemented method of preventing software audio customization in a personal computing device comprising main circuitry comprising a central processing unit (CPU), audio processing circuitry, and memory, the method comprising: defining, in system management firmware securely signed and stored in the memory, a record of an expected audio signal path to an audio processing element implemented by the main circuitry, the audio processing element configured to receive a feedback signal via the expected audio signal path from a component of the audio processing circuitry downstream from the main circuitry.

### TECHNICAL FIELD

The present disclosure relates to systems and methods of audio processing.

### BACKGROUND

Audio processing in personal computers (PCs) is typically implemented primarily in software. For example, in operating systems such as the Windows Operating System from Microsoft Corporation, audio processing is implemented using audio processing objects (APOs). An APO is an object that contains an algorithm which provides a specific digital signal processing (DSP) effect (an “audio effect”). APOs typically runs on a central processing unit (CPU) of a PC, or a DSP integrated into a system on chip (SoC) of the PC. APOs may compensate for speaker and/or acoustic design characteristics or provide for improved and/or optimized audio output from the PC.

Performing software processing of audio streams within an operating system can lead to high power consumption. As such, is it known to offload some audio processing to an on-chip digital signal processor (DSP) local to the CPU running the APO. However, in such configurations, the DSP may not be able to support all audio processing modes required. As such, an APO is typically still required to achieve a level of audio quality intended by PC manufacturers.

In practice, the reliance on dedicated APOs to achieve quality audio effects for PCs leads to several problems. Because APO software can be of considerable size, PC users and or information technology (IT) departments can view APOs as undesirable or unnecessary (so-called “bloatware”), and delete such software from the PCs or not include them in a corporate software image. As a result, PC original equipment manufacturers (OEMs) cannot be confident that PCs which they manufacture operate in the manner they intended, potentially leading to negative customer experience.

### SUMMARY

Embodiments of the present disclosure aim to address or at least ameliorate one or more of the above issues by providing a system architecture for a PC which relies on the presence of an APO to verify an audio path in the system. The audio path is defined in system management firmware which is securely signed and stored in memory of the PC. Removal of a software APO or an associated audio driver leads to corruption of the audio path such that audio no longer functions on the PC. In preventing or deterring removal of the APO by a user, quality of audio output from the PC can be ensured.

According to an aspect of the disclosure, there is a computer-implemented method in a personal computing device comprising main circuitry comprising a central processing unit (CPU), audio processing circuitry, and memory, the method comprising: defining, in system management firmware securely signed and stored in the memory, a record of an expected audio signal path to an audio processing element implemented by the main circuitry, the audio processing element configured to receive a feedback signal via the expected audio signal path from a component of the audio processing circuitry downstream from the main circuitry.

The method may further comprise: instantiating an audio signal path through the main circuitry and the audio processing circuitry; comparing the audio signal path to the record of the expected audio signal; and on determining a mismatch between the audio signal path and the expected audio signal path, preventing output of the audio signal from the personal computing device.

The method may further comprise instantiating the audio processing element on the audio processing circuitry.

The audio processing element may be a passive audio processing element.

The audio processing element may be configured in a passthrough mode.

The audio processing element may be implemented by the CPU.

The main circuitry may comprise a central processing unit (CPU) and a digital signal processor (DSP). The audio processing element may be implemented by the DSP.

The DSP and CPU may be integrated on a single integrated circuit (IC).

The audio processing circuitry may comprise one or more of: a smart amplifier; an analog-to-digital converter; a digital-to-analog converter; and an audio codec.

The feedback signal may comprise an active noise cancellation signal.

The system management firmware may comprise system management basic input output system (SMBIOS) firmware or unified extensible firmware interface (UEFI) firmware.

The method may further comprise, upon uninstallation of a streaming driver extension or an offload engine driver extension installed in the memory by a user of the personal computing device, determining based on the record of the phantom hardware element, corruption of audio signal path in the personal computing device.

The method may further comprise, in response to determining corruption of the audio path, disabling the audio path.

The method may further comprise, in response to determining corruption of the audio path, outputting an error message to the user.

The method may further comprise, upon reinstallation of the streaming driver extension or the offload engine driver extension by the user of the personal computing device, enabling the audio path.

According to another aspect of the disclosure, there is provided at least one non-transitory machine-readable medium comprising software instructions which, when executed by processing circuitry, cause the processing circuitry to implement the method described above.

According to another aspect of the disclosure, there is provided a personal computing device, comprising: main circuitry comprising a central processing unit; peripheral audio processing circuitry; firmware memory comprising system management (SM) firmware, the firmware comprising a record of an expected audio signal path to an audio processing element implemented by the main circuitry, the audio processing element configured to receive a feedback signal via the expected audio signal path from a component of the peripheral audio processing circuitry downstream from the main circuitry.

The personal computing device may further comprise processor memory comprising instructions which when executed by the CPU cause the CPU to: instantiate an audio signal path through the main circuitry and the peripheral audio processing circuitry; compare the audio signal path to the record of the expected audio signal; and on determining a mismatch between the audio signal path and the expected audio signal path, determine that the audio signal path is corrupt.

On determining the audio signal path is corrupt, output of the audio signal from the personal computing device may be prevented.

The CPU may be configured to disable operation of the peripheral audio processing circuitry in response to uninstallation of a streaming driver extension or an offload engine driver extension by a user.

The audio processing circuitry may comprise one or more of: a smart amplifier; an analog-to-digital converter; an audio digital signal processor; a digital-to-analog converter; and an audio codec.

The personal computing device may comprise a laptop computer or a tablet computer.

Throughout this specification the word “comprises”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the present disclosure will now be described by way of non-limiting examples with reference to the drawings, in which:

FIG. 1 is schematic diagram of a known personal computer (PC) system;

FIG. 2 is a flow diagram illustrating processing of an audio signal by the PC system of FIG. 1;

FIG. 3 is diagram of an example hardware configuration table;

FIG. 4 is a flow diagram illustrating processing of an audio signal by the PC system of FIG. 1;

FIG. 5 is a flow diagram illustrating processing of an audio signal by the PC system of FIG. 1;

FIG. 6 is diagram of an example hardware configuration table; and

FIG. 7 is a flow diagram illustrating processing of an audio signal by the PC system of FIG. 1.

### DESCRIPTION OF EMBODIMENTS

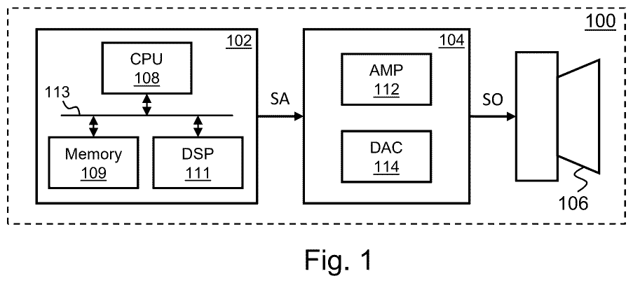

FIG. 1 is a schematic diagram of a known personal computer (PC) 100. For clarity of explanation, various elements of the PC 100 are not shown in FIG. 1.

The PC 100 comprises main circuitry 102, peripheral audio processing circuitry 104, and an output audio transducer 106.

The main circuitry 102 comprises a central processing unit (CPU) 108, a memory 109, and a digital signal processor (DSP) 111. The CPU communicates with the memory 109 and DSP via a bus 113. The memory 109 may store instructions which, when executed by the CPU 108 may cause the processor to generate an audio signal. Alternatively, the audio signal may be generated elsewhere in the main circuitry 102 (such as on the DSP 111) or external to main circuitry 102. The CPU 108 may be configured to run one or more audio processing objects (APOs) which may also be stored in the memory 109. Thus, the CPU 108 may be configured to process the audio signal to generate a processed audio signal SA which may be stored in the memory 109 and/or transmitted to the peripheral audio processing circuitry 104. Additionally, or alternatively, the DSP 111 may be configured to process the audio signal to generate a processed audio signal SA. The DSP may be integrated on to the same system on chip (SoC) as the CPU 108 and the memory 109.

The peripheral audio processing circuitry 104 may comprise an amplifier 112 and a digital-to-analog converter (DAC) 114. The DAC 114 may be configured to convert processed audio signal SA to an analog audio signal SO to be output to the transducer 106. The amplifier 112 may be configured to amplify the processed audio signal SA for output as the output signal SO. Amplification may be performed in the digital domain (before conversion by the DAC 114) or in the analog domain (after conversion by the DAC 114). The output signal SO is then output to the transducer 106 to be played back to the user.

The CPU 108 may be configured to run an operating system (OS), such as the Windows Operating System from Microsoft. To enable communication between the OS running on the CPU 108 and peripheral devices such as the DSP 111, and the peripheral audio processing circuitry 104, one or more drivers and driver extensions may be stored in the memory 109 of the main circuitry 102. Some such drivers and driver extensions enable the functioning of audio in the PC 100.

For example, a streaming driver may be provided to set up audio streams through the DSP 111. A streaming driver extension may also be provided to expand the streaming capability of the PC 100. The streaming driver extension may indicate to the streaming driver how modules of the DSP 111 are interconnected.

In another example, an offload engine driver may be provided to process offloaded audio streams. Offloaded audio streams are those audio streams which are processed by components other than the CPU 108, such as by the DSP 111. An offload engine driver extension may be provided to further expand the offload capability of PC 100. The offload engine driver extension may indicate where to find particular DSP modules (firmware) image files for loading into the DSP 111. Each DSP module image file may define one or more audio effects (or signal processing steps) which may be loaded onto the DSP 111.

It will be appreciated that removal by a user or administrator of the PC 100 of drivers and driver extensions may lead to malfunction or suboptimal performance of one or more elements of the PC 100. For example, removal of the streaming audio driver or driver extension may lead to no audio out and/or input capability of the PC 100. In another example, removal of offload engine driver or driver extension may lead to malfunctioning off offload of processed from the CPU 108 to other processing hardware of the PC 100. Whilst removal of a driver may lead to complete disfunction of a related peripheral or process, removal of a driver extension may lead only to suboptimal performance of that peripheral or process. As such, a user or administrator PC 100 might remove an audio driver extension without an immediately noticeable consequence to audio quality.

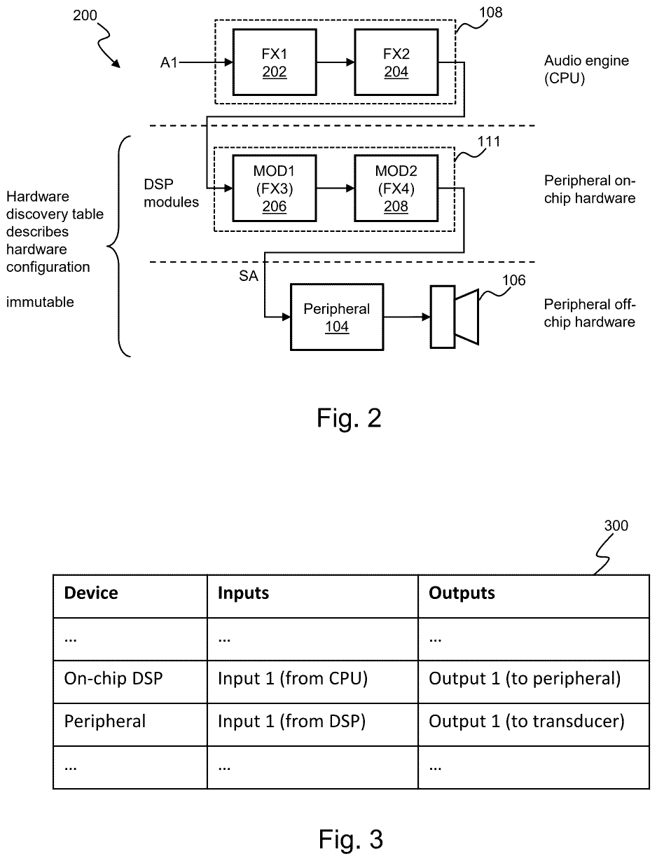

FIG. 2 is a flow diagram illustrating an example audio processing flow 200 for the PC 100 shown in FIG. 1.

One or more applications running on the main circuitry 102 may initialise an audio stream A1. As noted above, the audio stream may be initialised by an audio streaming driver in cooperation with an audio streaming driver extension.

An APO running on the CPU 108 may apply one or more software audio effects 202, 204 to the audio stream A1. In addition, one or more audio effects FX3, FX4 may be applied by the DSP 111 of the main circuitry 102 via respective DSP modules 206, 208. The DSP modules 206, 208 may be loaded from one or more firmware images onto memory (not shown) of the DSP 111. As noted above, loading of DSP modules 206, 208 may be achieved by an offload engine driver and offload engine driver extension.

In the example shown in FIG. 2, the audio stream A1 undergoes signal processing by the CPU 108 and subsequently by the DSP 111 to generate the processed audio signal SA which is provided to the peripheral audio processing circuitry 104.

The skilled person will appreciate that the configuration of PC 100's hardware, including peripheral devices and routing to those devices is stored in system management firmware, such as basic input/output system (BIOS) firmware or unified extensible firmware interface (UEFI) firmware. Such configuration information will include the configuration of the DSP 111 and other peripheral hardware, such as the peripheral audio processing circuitry 104.

An example format for storing configuration information in system management firmware is the Discovery and Configuration (DisCo) specification from MIPI Appliance Inc. A DisCo specification defines a uniform software architecture that can be used with a device's host operating system to enumerate controllers, busses and components. Whatever format the hardware configuration information is stored in system management firmware, such firmware or components thereof are commonly digitally signed or encrypted by a manufacturer of the PC 100 so that changes cannot be made without ownership of the associated public-private key pair. In doing so, the hardware configuration information cannot be altered by a third party other than that which holds a private key associated with signed system management firmware instance. The hardware configuration is thus substantially immutable.

Embodiments of the present disclosure rely on the immutability of the hardware configuration information coupled with the fact that operating systems use this hardware configuration information to check whether system hardware is configured as it should be, i.e. in accordance with hardware configuration information stored in system management firmware.

FIG. 3 illustrates an example hardware configuration table 300 for the PC 100, which shows and example format for storing hardware configuration information in system management firmware. It will be appreciated that the hardware configuration table 300 is a simplified graphical example for explanatory purposes only. The hardware configuration information may be stored in any conceivable format. Whilst in FIG. 3 only audio hardware configuration is shown, it will be appreciated that other hardware configuration may be provided in the table 300 which is not shown.

In this example, the table 300 defines an audio path from the CPU 108, through the DSP 111 to the peripheral audio processing circuitry 104 to the transducer 106.

As noted above, as part of the initialisation of the audio stream A1, a crosscheck may be performed by the operating system running of the PC 100 between, on the one hand, the audio hardware configuration initialised by the audio streaming driver and driver extension, and on the other hand, the hardware configuration defined in the hardware configuration table 300. A determination of a correspondence of actual vs stored hardware configurations (as defined in the table 300) will enable processing of the audio stream through the audio path to the transducer 106. A determination of a mismatch of actual and stored hardware configuration will lead the operating system determining an error in the signal path to the transducer 106, which may lead to an error in initialisation of the PC 100's audio path.

Whilst in some situations removal of driver software may lead to complete malfunction of audio of the PC 100, in certain situations, removal of driver software may lead only to a deterioration of audio, with baseline audio functionality not affected by such actions.

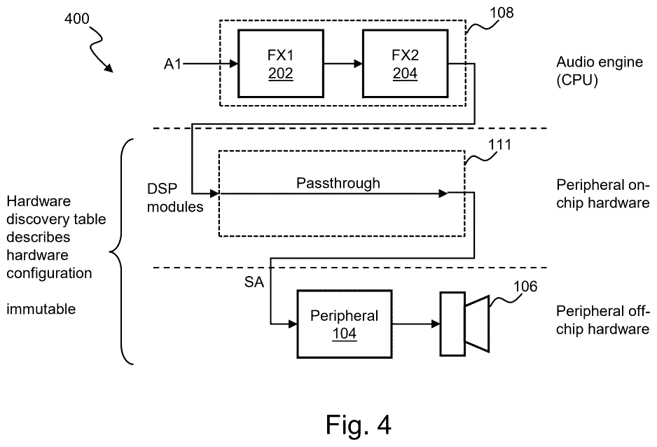

FIG. 4 illustrate an example of such a situation in which the streaming driver extension or the offload engine driver is uninstalled from the PC 100. FIG. 4 is a flow diagram illustrating an audio processing flow 400 which is a variation of the flow shown in FIG. 2 in a situation where the streaming driver extension and/or the offload engine driver is not present on the PC 100 (due to uninstallation, for example). Without the offload engine driver extension, the CPU 108 has no knowledge about what DSP modules should be loaded onto the DSP 111. Without the presence of the streaming driver extension, the CPU 108 has no knowledge about routing of signals through the DSP 111. In either case, the DSP 111 functions in a passthrough mode in which no audio processing is performed by the DSP 111. Since the signal path between the CPU 108, DSP 111 and peripheral audio processing circuitry 104 still corresponds to the hardware configuration table 300 shown in FIG. 3. As such, whilst the audio processing has deteriorated, the audio function of the PC 100 continues to function at a baseline level, albeit with reduced signal processing due to the DSP 111 not providing any signal processing).

Thus, users or administrators of the PC 100 are able to uninstall the streaming driver extension without critically affecting the basic audio functionality of the PC 100.

To address one or more of the above problems, embodiments of the present disclosure proposed to include in a hardware configuration table, a description of a DSP module that requires feedback from downstream circuitry. In doing so, uninstallation of driver extensions such as the audio streaming driver extension of offload engine driver extension leads to malfunction of the audio stream. Removal of such software is therefore not practically possible if audio functionality is to be maintained.

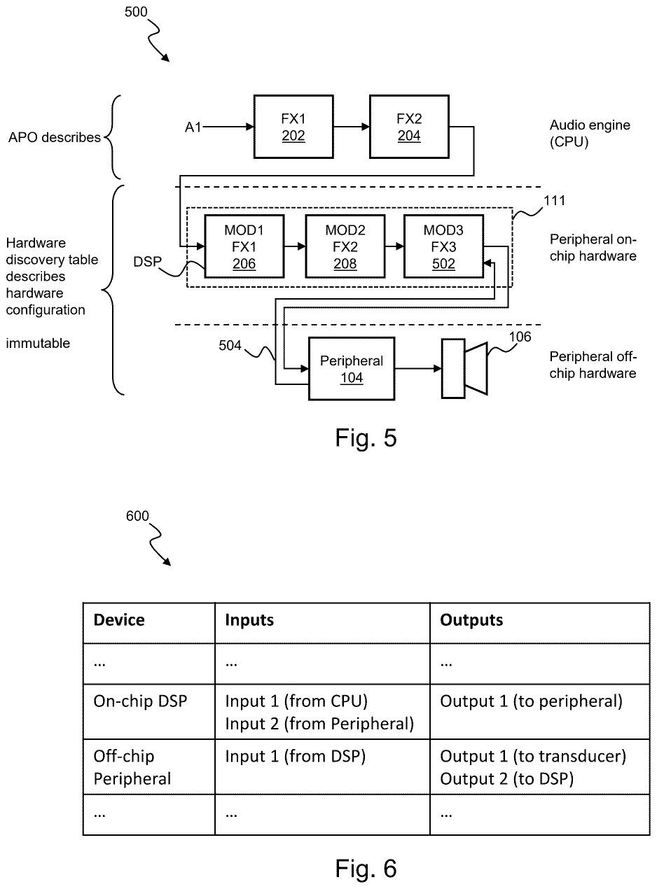

FIG. 5 is a flow diagram illustrating an example audio processing flow 500 which is a variation of the flow 200 shown in FIG. 2. The flow 500 differs in that an additional DSP module 502 has been loaded onto the DSP 111. As noted above, loading of DSP module 502 onto the DSP 111 is facilitated by the offload driver and offload engine driver extension. The additional DSP module 502 may be a dummy or passive module. In other words, the additional DSP module 502 may be operable in a passthrough mode applying no audio effects. Alternatively, the additional DSP module 502 may be configured to apply one or more effects. In either case, the additional DSP module 502 comprises an input for receiving a signal via a feedback signal path 504 from downstream audio circuitry, such as the peripheral audio processing circuitry 104.

FIG. 6 illustrates an example hardware configuration table 600 for the PC 100, which shows and example format for storing hardware configuration information associated with the DSP 111 in system management firmware. As with the hardware configuration table 300 of FIG. 3, it will be appreciated that the hardware configuration table 500 is a simplified graphical example for explanatory purposes only.

The table 600 defines an audio path from the CPU 108, through the DSP 111 and peripheral audio processing circuitry 104 to the transducer 106, including a feedback path from the peripheral audio processing circuitry 104 to the DSP 111 (“Output 2” of off-chip peripheral audio processing circuitry 104 to “Input 2” of DSP 111).

It can be seen from the hardware configuration table 600 that the hardware description provided in the system management configuration comprises a description of a DSP 111 and peripheral circuitry 104 and their interconnections which matches the physical implementation shown in FIG. 4. A check of this correspondence by the operating system would therefore pass, allowing operation of the audio stream without error.

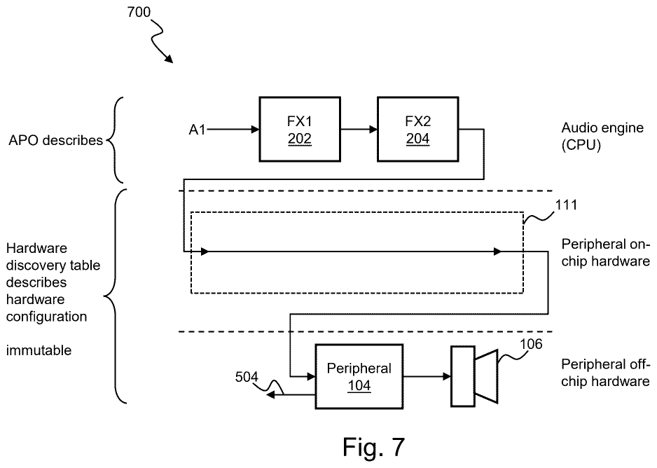

FIG. 7 is a flow diagram illustrating an example audio processing flow 700 which is a variation of the flow 500 shown in FIG. 5 in a situation where the streaming driver extension and/or the offload engine driver is not present on the PC 100 (due to uninstallation, for example). Without the offload engine driver extension, the CPU 108 has no knowledge about what DSP modules should be loaded onto the DSP 111. Without the presence of the streaming driver extension, the CPU 108 has no knowledge about routing of signals through the DSP 111. In either case, the DSP 111 functions in a passthrough mode in which no audio processing is performed by the DSP 111. However, in contrast to the example in FIG. 3, the actual physical configuration of the DSP 111 and peripheral audio processing circuitry 104 no longer matches the hardware configuration table 500 shown in FIG. 5, since the feedback signal path 504 is not present between the peripheral audio processing circuitry 104 and the DSP 111. In view of this mismatch, audio functionality of the audio steam A1 ceases to exist.

Thus, by describing, in a hardware configuration file stored and digitally signed in immutable system management firmware, a feedback path to the DSP 111 from a peripheral downstream circuit element, the removal of driver software which is critical to intended functionality of audio processing circuitry by a PC manufacturer can be prevented.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. A computer-implemented method in a personal computing device comprising main circuitry comprising a central processing unit (CPU), audio processing circuitry, and memory, the method comprising:
defining, in system management firmware securely signed and stored in the memory, a record of an expected audio signal path to an audio processing element implemented by the main circuitry, the audio processing element configured to receive a feedback signal via the expected audio signal path from a component of the audio processing circuitry downstream from the main circuitry.

2. The method of claim 1, further comprising:
instantiating an audio signal path through the main circuitry and the audio processing circuitry;
comparing the audio signal path to the record of the expected audio signal; and
on determining a mismatch between the audio signal path and the expected audio signal path, preventing output of the audio signal from the personal computing device.

3. The method of claim 1, further comprising instantiating the audio processing element on the audio processing circuitry.

4. The method of claim 1, wherein the audio processing element is a passive audio processing element.

5. The method of claim 1, wherein the audio processing element is configured in a passthrough mode.

6. The method of claim 1, wherein the audio processing element is implemented by the CPU.

7. The method of claim 1, wherein the main circuitry comprises a central processing unit (CPU) and a digital signal processor (DSP), wherein the audio processing element is implemented by the DSP.

8. The method of claim 7, wherein the DSP and CPU are integrated on a single integrated circuit (IC).

9. The method of claim 1, wherein audio processing circuitry comprises one or more of:
a smart amplifier;
an analog-to-digital converter;
a digital-to-analog converter; and
an audio codec.

10. The method of claim 1, wherein the feedback signal comprises an active noise cancellation signal.

11. The method of claim 1, wherein the system management firmware comprises system management basic input output system (SMBIOS) firmware or unified extensible firmware interface (UEFI) firmware.

12. The method of claim 1, further comprising:
upon uninstallation of a streaming driver extension or an offload engine driver extension installed in the memory by a user of the personal computing device, determining based on the record of the phantom hardware element, corruption of audio signal path in the personal computing device.

13. The method of claim 12, further comprising, in response to determining corruption of the audio path, disabling the audio path.

14. The method of claim 12, further comprising, in response to determining corruption of the audio path, outputting an error message to the user.

15. The method of claim 12, further comprising:
upon reinstallation of the streaming driver extension or the offload engine driver extension by the user of the personal computing device, enabling the audio path.

16. At least one non-transitory machine-readable medium comprising software instructions which, when executed by processing circuitry, cause the processing circuitry to implement the method of claim 1.

17. A personal computing device, comprising:
main circuitry comprising a central processing unit;
peripheral audio processing circuitry;
firmware memory comprising system management (SM) firmware, the firmware comprising a record of an expected audio signal path to an audio processing element implemented by the main circuitry, the audio processing element configured to receive a feedback signal via the expected audio signal path from a component of the peripheral audio processing circuitry downstream from the main circuitry.

18. The personal computing device of claim 17, further comprising processor memory comprising instructions which when executed by the CPU cause the CPU to:
instantiate an audio signal path through the main circuitry and the peripheral audio processing circuitry;
compare the audio signal path to the record of the expected audio signal; and
on determining a mismatch between the audio signal path and the expected audio signal path, determine that the audio signal path is corrupt.

19. The personal computing device of claim 18, wherein on determining the audio signal path is corrupt, output of the audio signal from the personal computing device is prevented.

20. The personal computing device of claim 18, wherein the CPU is configured to disable operation of the peripheral audio processing circuitry in response to uninstallation of a streaming driver extension or an offload engine driver extension by a user.

21. The personal computing device of claim 17, wherein the audio processing circuitry comprises one or more of:
a smart amplifier;
an analog-to-digital converter;
an audio digital signal processor;
a digital-to-analog converter; and
an audio codec.

22. The personal computing device of claim 17, wherein the personal computing device comprises a laptop computer or a tablet computer.
